(19) United States
(12) Patent Application Publication
(10) Pub. No.: US 2008/0049278 A1
(43) Pub. Date: Feb. 28, 2008

(54) OPTICAL INFORMATION RECORDING MEDIUM AND HOLOGRAM FORMING METHOD FOR OPTICAL INFORMATION RECORDING MEDIUM

(75) Inventor: Satoshi Kobayashi, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/837,158

(22) Filed: Aug. 10, 2007

(30) Foreign Application Priority Data
Aug. 11, 2006 (JP) 2006-243434

(51) Int. Cl. G03H 1/18; G03H 1/08

(52) U.S. Cl. 359/3; 359/9

(57) ABSTRACT

An optical information recording medium provided with a hologram is disclosed. The optical medium comprises a recording layer formed on one surface of a first substrate, and a semipermeable reflective layer formed on the recording layer. The optical medium further comprises a second transmittance substrate bonded to the first transmittance substrate on the side where the recording layer and the semipermeable reflective layer are provided, a heat-generating layer formed on the second transmittance substrate, and a reflective layer formed on the heat-generating layer and formed with pixels of a first hologram by being transformed in association with transformation of the heat-generating layer. The reflective layer at least includes pixels of a second hologram formed of concavities and convexities in the direction of the thickness thereof. Accordingly, the hologram is utilized for preventing the falsification or the ill-usage even for a small-amount multi-product application.

### BACKGROUND OF TIE INVENTION

1. Field of the Invention

The present invention relates to an optical information recording medium having, for example, a disk-shape or a card-shape. More specifically, the invention relates to an optical information recording medium provided with a hologram and a hologram forming method for an optical information recording medium.

2. Description of the Related Technology

A disk-shaped optical information recording medium such as CD-R, DVD+R, and Blu-Ray Disk has a structure in which a recording layer and a reflective layer are formed on one of the surfaces of a transmittance substrate, and is configured in such a manner that data is recorded in the recording layer by being irradiated with a laser beam from the side of the other surface of the substrate.

On the other hand, a hologram is used for preventing falsification or other purposes in bank bills, credit cards, securities, and so on. An inexpensive hologram forming method is proposed in JP-A-2005-309441. A hologram forming method by laser-irradiation is proposed in JP-A-1-271787.

An optical information recording medium using the hologram is proposed in JP-A-2001-195783. More specifically, as shown in FIG. 6, an optical recording medium of a two sided recording system including a first substrate 1A having an information recording surface 3a on one side, a second substrate 1B having an information recording surface 3b on one side, a base material 8 one of the surfaces of which is bonded with the recording surface 3a of the first substrate 1A, the other one of the surfaces of which is bonded with the recording surface 3b of the second substrate 1B, and a first printable layer formed on a first surface of the base material 8 for displaying display information which can be viewed via the first substrate 1A, concavities and convexities formed on the first surface of the base material 8, a reflective film coated on the first surface including the concavities and convexities, wherein the display information on the first printable layer is displayed by a hologram 10a including the part of the concavities and convexities and the reflective film.

However, in the optical information recording medium disclosed in JP-A-2001-195783, since a data recording surface is formed on a portion of the base material different from a portion where the hologram is formed in advance, there is a problem that the hologram is subject to falsification or ill-usage by, for example, separating the base material and the data recording surface.

### SUMMARY OF CERTAIN INVENTIVE ASPECTS

One inventive aspect relates to an optical information recording medium including a data recording part and a hologram drawing part, the hologram drawing part including pixels for a second hologram including concavities and convexities formed in advance on a reflective layer of the hologram drawing part in the direction of thickness of the reflective layer and pixels for a first hologram formed on the reflective layer by laser-irradiation on the hologram drawing part. Therefore, when an attempt is made to separate the pixels of the first hologram formed by laser-irradiation, these pixels are separated from the pixels of the second hologram formed in advance, so that the falsification or ill-usage may be distinguished easily.

Another inventive aspect relates to a hologram forming method for an optical information recording medium for forming pixels of a first hologram on the reflective layer on which the pixels of the second hologram are formed in advance by irradiating the hologram recording layer with a laser beam from the same side as the side from which the laser beam is irradiated when recording data. Therefore, falsification or ill-usage of the optical information recording medium with the hologram by the laser-irradiation may be prevented.

Another inventive aspect relates to an optical information recording medium having a first transmittance substrate, a recording layer formed on one surface of the first transmittance substrate, a semipermeable reflective layer formed on the recording layer, and being capable of recording information by laser-irradiation on the recording layer from the side of the other surface of the first transmittance substrate, including a second transmittance substrate bonded to a surface of the first transmittance substrate on the side where the recording layer and the semipermeable reflective layer are provided, a heat-generating layer which is formed on the second transmittance substrate, the heat-generating layer generating heat and being transformed by absorbing a laser beam, a reflective layer formed on the heat-generating layer and formed with pixels of a first hologram by being transformed in association with transformation of the heat-generating layer, and a transformation layer formed on the reflective layer, and the reflective layer at least includes pixels of a second hologram formed of concavities and convexities formed thereon in advance in the direction of the thickness thereof.

According to the first technical means, when an attempt is made to separate the first hologram formed optionally by laser-irradiation, it is separated together with the second hologram which is provided in advance. Therefore, falsification or ill-usage of the hologram may be distinguished easily, and hence the hologram is utilized as means for preventing falsification or ill-usage even for a low volume multi-product application.

Preferably, the optical information recording medium further includes a transparent protective layer formed on the transformation layer.

In this configuration, deterioration or the like of the respective layers from the side of the transformation layer may be prevented.

Preferably, the reflective layer is formed with concavities and convexities in the direction of the thickness thereof by pressing the surface thereof with a metal mold formed with concavities and convexities on the surface thereof.

In this configuration, the second hologram is formed relatively easily on the reflective layer.

Preferably, the second transmittance substrate is formed with concavities and convexities on the side where the heat-generating layer of the second transmittance substrate is formed for forming pixels of the second hologram on the reflective layer.

In this configuration, the second hologram is formed on the reflective layer at high degree of accuracy without variations.

Preferably, the second transmittance substrate is formed with a spiral ditch for tracking on the surface where the heat-generating layer of the second transmittance substrate is formed.

In this configuration, the first hologram may be formed with high degree of accuracy in the radial direction.

Another inventive aspect relates to a hologram forming method for an optical information recording medium having a recording layer and a semipermeable reflective layer on one surface of a first transmittance substrate in sequence from the side of the first transmittance substrate, and a heat-generating layer, a reflective layer having pixels of a second hologram and a transformation layer formed on the first transmittance substrate in sequence via a second transmittance substrate bonded on the surface of the first transmittance substrate where the recording layer and the semipermeable reflective layer are provided, wherein pixels for a first hologram is formed on the reflective layer on which the pixels of the second hologram are formed in advance by irradiating the heat-generating layer with a laser beam via the second transmittance substrate from the same side as the side irradiated with the laser beam when recording data.

In this configuration, data recording and hologram formation are achieved without a troublesome work to reverse the disk.

Preferably, the pixels of the second hologram are formed at shorter pitch than the pitch of the pixels of the first hologram.

In this configuration, mutual interference of the first hologram and the second hologram may be prevented, and the first and second holograms may be reproduced at different positions. Since the pitch of the pixels of the second hologram are shorter than the pitch of the pixels of the first hologram, falsification or ill-usage of the hologram formed only through laser-irradiation may be prevented.

Preferably, the irradiating the recording layer with the laser beam is performed simultaneously with the laser-irradiation on the heat-generating layer.

In this configuration, the optical information recording medium which may prevent the falsification or the ill-usage may be fabricated in a short time.

The above-described object, other objects, configuration characteristics, effects and advantages will be apparent from description shown below and attached drawings. Aspects of the invention are described in the JP 2006-243434 priority application which is incorporated herein by reference in its entirety.

### BRIEF DESCRIPTION OF THE DRAWINGS

FIG. 1 is a partly enlarged cross-sectional view showing an internal structure of an optical information recording medium according to a first embodiment of the invention;

FIG. 2 is a partly enlarged perspective view showing the internal structure of the optical information recording medium according to the first embodiment;

FIG. 3 is a drawing for explaining a relation between the pixel length and a view angle of a hologram;

FIG. 4 is a partly enlarged cross-sectional view showing an internal structure of an optical information recording medium in a second embodiment of the invention;

FIG. 5 is a partly enlarged perspective view for explaining the internal structure of the second embodiment;

FIG. 6 is a partly enlarged cross-sectional view showing an example of related art.

### DESCRIPTION OF CERTAIN EMBODIMENTS

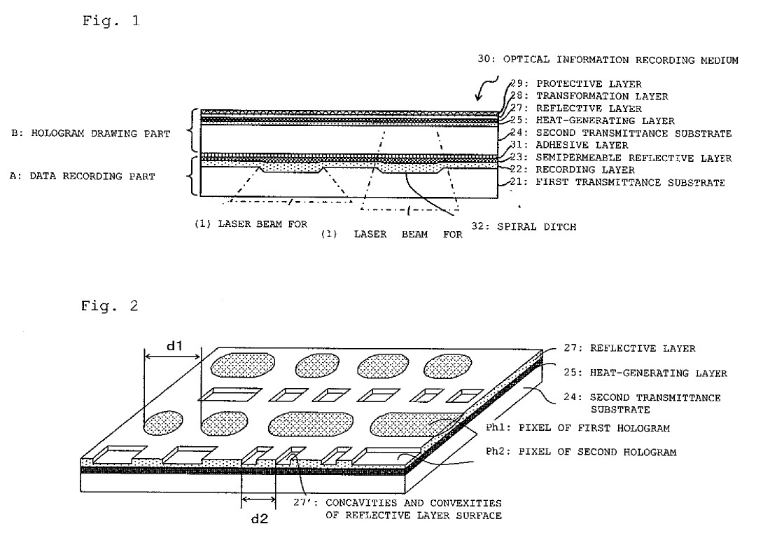

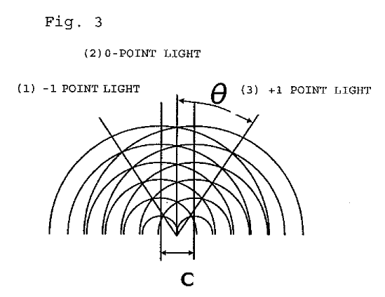

Referring now to FIG. 1 to FIG. 3, a first embodiment of an optical information recording medium will be described. FIG. 1 is a partially enlarged cross-sectional view showing an internal structure of an optical information recording medium 30 according to the first embodiment. FIG. 2 is a partially enlarged perspective view in which part of the internal structure of the optical information recording medium 30 is omitted. FIG. 3 is a drawing for explaining a relation between pitch and a view angle of pixels of hologram in the first embodiment.

As shown in FIG. 1, the optical information recording medium 30 according to the first embodiment has a structure in which a data recording part A and a hologram drawing part B are bonded with an adhesive layer 31.

More specifically, the optical information recording medium 30 in the first embodiment includes a first transmittance substrate 21, a recording layer 22 formed on one surface of the first transmittance substrate 21, a semipermeable reflective layer 23 formed on the recording layer 22, so that information can be recorded by irradiating the recording layer 22 with a laser beam on the side of the other surface of the first transmittance substrate 21, the optical information recording medium 30 further includes a second transmittance substrate 24 bonded to a surface of the first transmittance substrate 21 having the recording layer 22 and the semipermeable reflective layer 23, a heat-generating layer 25 formed on the second transmittance substrate 24 for absorbing the laser beam and generating heat and being transformed thereby, a reflective layer 27 formed on the heat-generating layer 25 and formed with pixels Ph1 of a first hologram by being transformed in association with the transformation of the heat-generating layer 25, a transformation layer 28 formed on the reflective layer 27, and pixels Ph2 of a second hologram including concavities and convexities 27′ formed in advance on the reflective layer 27 in the direction of the thickness thereof.

The optical information recording medium 30 in the first embodiment is further provided with a transparent protective layer 29 on the transformation layer 28.

The optical information recording medium 30 in the first embodiment is formed with the concavities and convexities 27′ on the reflective layer 27 in the direction of the thickness thereof by pressing the surface of the reflective layer 27 with a metal mold or the like on which the concavities and convexities 27′ are formed on the surface thereof.

The optical information recording medium 30 in the first embodiment has substantially the same structure as normal DVD-R optical disk other than that the heat-generating layer 25, the reflective layer 27, the transformation layer 28, and the transparent protective layer 29 are formed on the second transmittance substrate 24, and the pixels Ph2 of the second hologram are formed on the reflective layer 27. The second hologram provided on the reflective layer 27 can be viewed through the transparent protective layer 29 from the side of a label surface so as to be reproducible.

A preferred embodiment of the first transmittance substrate 21 is as follows. That is, the first transmittance substrate 21 is formed of transparent resin such as polycarbonate, acryl resin or the like, and is formed on a substrate into a predetermined shape (doughnut shape in the case of the optical disc) through a method such as injection molding. Alternatively, it is also possible to use UV curing resin. The first transmittance substrate 21 may be the one formed by applying the transparent resin to a predetermined thickness and curing the same through a method such as spin coating in addition to the one formed on a substrate of a predetermined shape (doughnut shape in the case of the optical disc) through the method such as the injection molding, and the thickness thereof is preferably several μm to several hundred μm.

A preferred embodiment of the recording layer 22 is as follows. That is, the recording layer 22 includes organic dye, and pits are formed by irradiation of a laser beam having a predetermined wavelength, so that data is recorded. The organic dye is preferably phthalocyanine, cyanine, or azo coloring matter. Data information such as music, image, or computer program may be recorded on and/or reproduced from the recording layer 22 by irradiation of a laser beam having the same as or different from the laser beam that the heat-generating layer 25 is irradiated with.

A preferred embodiment of the semipermeable reflective layer 23 is as follows. That is, the semipermeable reflective layer 23 reflects the laser beam for data recording and/or reproducing, and allows a laser beam for hologram drawing to pass through, and is a dielectric multilayer formed by laminating metal (for example, Ag, Ag alloy, and Al) films or oxide films having different refractive indexes.

In order to enhance the reflectance of the laser beam for data recording of DVD and the transmission factor of the laser beam for first hologram drawing, it is preferable to select the dielectric multilayer whose material and thickness are controlled as needed. It is also possible to realize the first semipermeable reflective layer 23 and the recording layer 22 with a structure corresponding to an L0 layer in the Dual standard of DVD+R.

A preferred embodiment of the adhesive layer 31 is as follows. In other words, epoxy and acryl based adhesive, for example, are preferable.

A preferable embodiment of the second transmittance substrate 24 is as follows. That is, the same material as the first transmittance substrate 21 may be used. The second transmittance substrate 24 may be the one formed by applying the transparent resin to a predetermined thickness and curing the same through a method such as spin coating in addition to the one formed on a substrate of a predetermined shape (doughnut shape in the case of the optical disc) through the method such as the injection molding, and the thickness thereof is preferably several μm to several hundred μm.

When the molded one as described above is used, the data recording part A formed on the first transmittance substrate 21 and the hologram drawing part B formed on the second transmittance substrate 24 may be integrated utilizing a DVD-R bonding process.

The second transmittance substrate 24 serves to secure the distance between the recording layer 22 of the data recording part A and the heat-generating layer 25 of the hologram drawing part B. Therefore, the thickness of the second transmittance substrate 24 is adjusted so that the distance from the first transmittance substrate 21 as a laser beam entrance surface to the protective layer 29 corresponds to the CD-R standard, whereby the respective laser beams that the recording layer 22 of the data recording part A and the heat-generating layer 25 of the hologram drawing part B are irradiated are able to collect light independently and preferably. Also, the influence of heat generated respectively from the recording layer 22 of the data recording part A and the heat-generating layer 25 of the hologram drawing part B may be separated by laser-irradiation, and the coloring matter may be prevented from dispersing from the heat-generating layer 25 on to the recording layer 22.

A preferable embodiment of the heat-generating layer 25 is as follows. That is, the heat-generating layer 25 is configured with a layer containing organic dye, organic ink, or the like, which includes the laser beam that this layer is irradiated with in its own optical absorption wavelength region so as to absorb the laser beam and generate heat or change the volume simultaneously with heat generation. The organic dye is preferably the phthalocyanine, cyanine, or azo coloring matter as in the case of the recording layer 22, and the organic dye preferably has the different optical absorption property from the recording layer 22.

The heat-generating layer 25 may be of a single-layer structure in which materials being different in molecular structure are mixed, or of a multilayered structure in which materials having different molecular structures are separated from each other for the purpose of increasing the efficiency of decomposition.

A preferred embodiment of the reflective layer 27 will be as follows. That is, the reflective layer 27 is resulted in melted transformation by heat generation of the heat-generating layer 25 or in transformation in association with the volume change of the heat-generating layer 25, so that the pixels of the first hologram are formed. Then, diffused reflection or transmission of visible light from or through this part makes the pixels Ph1 of the first hologram visible from the side of the label surface side so as to be reproducible. Also, by reflecting part of the laser beam reflected by this layer and returning the same to an optical recording device, a stable focus control is enabled. The reflective layer 27 is formed of metal, and the metal includes In having a low melting point as well as Ag, Ag alloy, Al, and Al alloy.

The reflective layer 27 is provided with the concavities and convexities 27′ in advance in the direction of the thickness of the reflective layer 27, and is formed with the pixels Ph2 of the second hologram. The concavities and convexities 27′ formed on the reflective layer 27 in the direction of the thickness are formed, for example, by pressing a metal die or the like having the concavities and convexities on the surface thereof against the surface of the reflective layer 27 after having formed the reflective layer 27, so that the concavities and convexities on the surface of the metal mold is transferred to the surface of the reflective layer 27. As another example, it is also possible to form the concavities and convexities on the surface of the second transmittance substrate 24 on the side where the heat-generating layer 25 is formed simultaneously with the molding of the second transmittance substrate 24 in advance, and then form the heat-generating layer and the reflective layer in sequence thereon so that the reflective layer is also formed with concavities and convexities caused by the concavities and convexities on the surface of the second transmittance substrate 24.

The transformation layer 28 is formed of transparent material which is subject to thermal deformation or pressure deformation or a layer having voids on a boundary face with respect to the reflective layer 27 so as to avoid inhibition of transformation of the reflective layer 27. The material which is subject to thermal deformation or pressure deformation includes, e.g., chain polymer, thermoplastic resin, and gelatinous high polymer resin or the like. In particular, the chain polymer includes, e.g., acryl-based, polystyrene-based, methyl styrene based, and rosin ester-based chain polymer.

A preferred embodiment of the protective layer 29 is as follows. That is, the protective layer 29 is formed of transparent resin such as acrylic UV curing resin or solvent-soluble type polymeric resin.

Referring now to FIG. 1 and FIG. 2, the first embodiment of a hologram forming method for an optical information recording medium will be described. FIG. 1 is a partly enlarged cross-sectional view for explaining the hologram forming method for an optical information recording medium according to the first embodiment, and FIG. 2 is a partly enlarged perspective view for explaining the hologram forming method according to the first embodiment with part of the structure is omitted.

The first embodiment of the hologram forming method for an optical information recording medium is a hologram forming method for an optical information recording medium 30 having the recording layer 22 and the semipermeable reflective layer 23 formed on one surface of the first transmittance substrate 21 in sequence from the side of the first transmittance substrate 21, and the heat-generating layer 25, the reflective layer 27 having the pixels Ph2 of the second hologram, and the transformation layer 28 are formed in sequence via the second transmittance substrate 24 bonded to a surface of the first transmittance substrate 21 having the recording layer 22 and the semipermeable reflective layer 23, wherein the pixels Ph1 of the first hologram is formed on the reflective layer 27 on which the pixels Ph2 of the second hologram is formed in advance by irradiating the heat-generating layer 25 with a laser beam via the second transmittance substrate 24 from the same side as the side where the laser beam is irradiated when recording data.

More specifically, as shown in FIG. 1, the optical information recording medium 30 in the first embodiment has a structure in which the data recording part A and the hologram drawing part B are bonded with the adhesive layer 31, and hence the laser beam for hologram drawing is irradiated from the side of the other surface of the first transmittance substrate 21, which is the same as the laser beam for data recording. The laser beam for hologram drawing is passed through the first transmittance substrate 21, the recording layer 22, the semipermeable reflective layer 23, the adhesive layer 31, and the second transmittance substrate 24, and is absorbed by the heat-generating layer 25, and the coloring matter of the heat-generating layer 25 is decomposed and generates heat, or is changed in volume simultaneously with heat generation. Then, a deformed portion is generated on the reflective layer 27 due to the melted transformation or volume change due to cracked gas of the coloring matter in the heat-generating layer 25. The deformed portion allows the visible light to be reflected diffusely, or to be transmitted, and hence portions where the amount of reflection is different from other portions of the reflective layer 27, that is, the pixels Ph1 of the first hologram is generated. This difference in amount of reflection enables visual recognition from the side of the label surface as a hologram drawing so as to be reproducible.

According to the hologram forming method for an optical information recording medium according to the first embodiment, a pitch d2 of the pixels Ph2 of the second hologram is shorter than a pitch d1 of the pixels Ph1 of the first hologram. In general, as shown in FIG. 3, the hologram is configured in such a manner that the reproduction of a hologram image is enabled with +1 point light which is at an angle θ from 0 point light and −1 point light which is at an angle −θ therefrom when the pitch of the pixels is set to d, and the smaller the pitch d of the pixels, the wider the view angle in which the hologram can be reproduced becomes. Therefore, in the first embodiment, the second hologram can be reproduced at a wider view angle than the first hologram.

In the description above, the pitch of the pixels represents the shortest length from among the lengths obtained by adding the length of one pixel and the distance to an adjacent pixel respectively in the pixels Ph1 of the first hologram and the pixels Ph2 of the second hologram.

According to the hologram forming method for an optical information recording medium according to the first embodiment, the laser-irradiation on the recording layer is performed simultaneously with the laser-irradiation on the heat-generating layer 25.

The laser beam for data recording that the recording layer 22 of the data recording part A is irradiated with and the laser beam for hologram drawing that the heat-generating layer 25 of the hologram drawing part B is irradiated with are different in focal distance, and hence the mutual interference may be avoided by the focus control of the optical recording device even when the laser beams of the same wavelength are used. It is also possible to differentiate the optical absorption property (absorbance) between the laser beam for data recording that the recording layer 22 of the data recording part A is irradiated with and the laser beam for hologram drawing that the heat-generating layer 25 of the hologram drawing part B is irradiated with. More specifically, the peak difference of the absorbance may be about 75 nm, preferably, 100 nm, and more preferably, 125 nm. For example, in the case of the DVD, since the wavelength of the laser beam for recording is more or less 660 nm in general, the laser beam for hologram drawing of about 785 nm in wavelength may be used.

In the optical recording device which is capable of recording both on DVD±R and CD-R, so called, in a multi drive, there is a type in which both a laser source for the DVD±R and a laser source for the CD-R are provided. When the multi drive as such is used, laser-irradiation on the heat-generating layer 25 of the hologram drawing part B may be performed simultaneously with the data recording on the recording layer 22 of the data recording part A by using the both light sources. This may be implemented by software which controls the optical recording device, not shown.

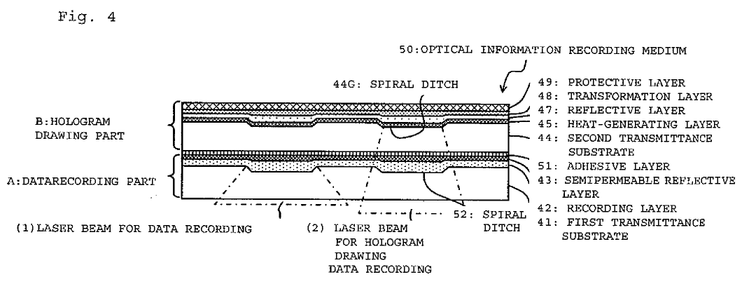

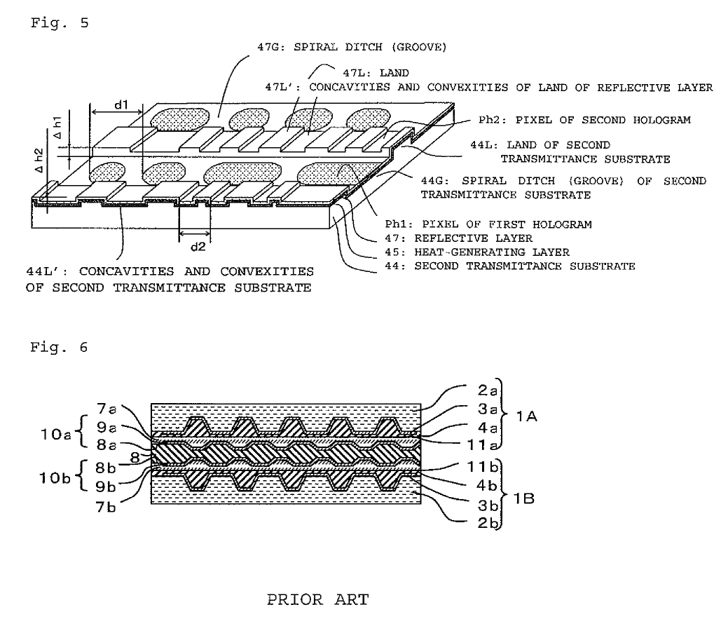

Referring now to FIG. 4 and FIG. 5, a second embodiment of the optical information recording medium will be described. FIG. 4 is a partly enlarged cross-sectional view showing an internal structure of an optical information recording medium 50 in the second embodiment, and FIG. 5 is a partly enlarged perspective view for explaining the internal structure of the second embodiment partly omitted.

As shown in FIG. 4, the optical information recording medium 50 in the second embodiment is similar to the first embodiment described above in that it has a structure in which the data recording part A and the hologram drawing part B are bonded with an adhesive layer 51.

More specifically, the optical information recording medium 50 of the second embodiment includes a first transmittance substrate 41, a recording layer 42 formed on one surface of the first transmittance substrate, and a semipermeable reflective layer 43 formed on the recording layer and information may be recorded by irradiating the recording layer 42 with a laser beam from the side of the other surface of the first transmittance substrate 41, and further includes a second transmittance substrate 44 bonded to the first transmittance substrate 41 on the surface where the recording layer 42 and the semipermeable reflective layer 43 are provided, a heat-generating layer 45 formed on the second transmittance substrate 44, the heat-generating layer 45 generating heat and being transformed by absorbing a laser beam, a reflective layer 47 formed on the heat-generating layer 45 and formed with the pixels Ph1 of the first hologram by being transformed in association with transformation of the heat-generating layer 45, and a transformation layer 48 formed on the reflective layer 47, and the reflective layer 47 at least having the pixels Ph2 of the second hologram formed of the concavities and convexities 47L′ formed thereon in advance in the direction of the thickness thereof.

The optical information recording medium 50 in the second embodiment further includes a transparent protective layer 49 on the transformation layer 48.

The second transmittance substrate 44 of the optical information recording medium 50 in the second embodiment is formed with concavities and convexities 44L′ on the surface of the second transmittance substrate 44 on which the heat generating layer 45 is formed for forming the pixels Ph2 of the second hologram on the reflective layer 47, and the size of the concavities and convexities 44L′ is, for example, 20 nm.

The second transmittance substrate 44 of the optical information recording medium 50 in the second embodiment is formed with a spiral ditch 44G for tracking on the surface of the second transmittance substrate 44 where the heat-generating layer 45 is formed, and the depth of the spiral ditch 44G is, for example 100 nm.

In the optical information recording medium 50 in the second embodiment there are two significant differences from the first embodiment shown above, the first one of which is that the second transmittance substrate 44 is formed with the concavities and convexities 44L′ on the surface where the heat-generating layer 45 is formed for forming the pixels Ph2 of the second hologram on the reflecting layer 47, and the second one of which is that the second transmittance substrate 44 is formed with the spiral ditch 440 for tracking on the surface where the heat-generating layer 45 is formed.

Other configurations, effects and advantages are the same as those in the first embodiment, and hence is omitted.

Referring now to FIG. 4 and FIG. 5, the second embodiment of a hologram forming method for an optical information recording medium will be described. FIG. 4 is a partly enlarged cross-sectional drawing for explaining the hologram forming method for an optical information recording medium according to the second embodiment, and FIG. 5 is a partly enlarged perspective view for explaining the hologram forming method in the second embodiment in which part of the structure is omitted.

The hologram forming method for an optical information recording medium according to the second embodiment is a hologram forming method for an optical information recording medium 50 having the recording layer 42 and the semipermeable reflective layer 43 on one surface of the first transmittance substrate 41 in sequence from the side of the first transmittance substrate 41, and the heat-generating layer 45, the reflective layer 47 having the pixels Ph2 of the second hologram and the transformation layer 48 formed on the first transmittance substrate 41 in sequence via the second transmittance substrate 44 bonded on the surface where the recording layer 42 and the semipermeable reflective layer 43 are bonded, wherein the pixels Ph1 for the first hologram is formed on the reflective layer 47 on which the pixels Ph2 of the second hologram are formed in advance by irradiating the heat-generating layer 45 with a laser beam via the second transmittance substrate 44 from the same side as the side irradiated with the laser beam when recording data.

More specifically, as shown in FIG. 4, the optical information recording medium 50 in the second embodiment has a structure in which the data recording part A and the hologram drawing part B are bonded with adhesive layer 51, and hence the first transmittance substrate 41 is irradiated with the laser beam for hologram drawing from the side of the other surface thereof which is the same as the laser beam for data recording. The laser beam for hologram drawing passes through the first transmittance substrate 41, the recording layer 42, the semipermeable reflective layer 43, adhesive layer 51, and the second transmittance substrate 44, and is absorbed by the heat-generating layer 45, and the coloring matter of the heat-generating layer 45 is decomposed and generates heat, or is changed in volume simultaneously with heat generation. Then, a deformed portion is generated on the reflective layer 47 due to the melted transformation or volume change due to cracked gas of the coloring matter in the heat-generating layer 45. The deformed portion allows the visible light to be reflected diffusely or to be transmitted, and hence portions where the amount of reflection is different from other portions of the reflective layer 47, that is, the pixels Ph1 of the first hologram is generated. This difference in amount of reflection enables visual recognition from the side of the label surface as a hologram drawing so as to be reproducible.

According to the hologram forming method for an optical information recording medium according to the second embodiment, the pitch d2 of the pixels Ph2 of the second hologram is shorter than the pitch d1 of the pixels Ph1 of the first hologram.

According to the hologram forming method for an optical information recording medium according to the second embodiment, the laser-irradiation on the recording layer is performed simultaneously with the laser-irradiation on the heat-generating layer 45.

Although the optical information recording medium of the DVD±R disk structure has been described in the second embodiment, the invention in not limited thereto, and may be applied to various types of the optical information recording medium such as CD-R, HD-DVD, or Blu-ray Disk.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not by itself be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium having a first substrate, a recording layer formed on one surface of the first substrate, and a semipermeable reflective layer formed on the recording layer, and being capable of recording information by laser-irradiation on the recording layer from the side of the other surface of the first substrate, comprising:
a second substrate bonded to a surface of the first substrate on the side where the recording layer and the semipermeable reflective layer are provided;
a heat-generating layer formed on the second substrate, the heat-generating layer generating heat and being transformed by absorbing a laser beam;
a reflective layer formed on the heat-generating layer and formed with pixels of a first hologram by being transformed in association with transformation of the heat-generating layer; and
a transformation layer formed on the reflective layer,
wherein the reflective layer at least comprises pixels of a second hologram of concavities and convexities formed thereon in advance in the direction of the thickness thereof.

2. The optical information recording medium according to claim 1, wherein the optical information recording medium further comprises a transparent protective layer formed on the transformation layer.

3. The optical information recording medium according to claim 1, wherein the reflective layer is formed with concavities and convexities in the direction of the thickness by pressing the surface of the reflective layer with a metal mold formed with concavities and convexities on the surface thereof.

4. The optical information recording medium according to claim 1, wherein the second substrate is formed with concavities and convexities on the side where the heat-generating layer is formed for forming pixels of the second hologram on the reflective layer.

5. The optical information recording medium according to claim 1, wherein the second substrate is formed with a spiral groove for tracking on the surface where the heat-generating layer is formed.

6. The optical information recording medium according to claim 1, wherein said first and second substrates are light transmitting substrates.

7. A method of forming a hologram on an optical information recording medium, the optical medium comprising a recording layer and a semipermeable reflective layer on one surface of a first substrate in sequence from the side of the first substrate, and a heat-generating layer, a reflective layer comprising pixels of a first hologram and a transformation layer formed on the first substrate in sequence via a second substrate bonded on the surface of the first substrate where the recording layer and the semipermeable reflective layer are provided, the method comprising:
forming pixels for a second hologram on the reflective layer by irradiating the heat-generating layer with a laser beam from the same side as the side irradiated with the laser beam when recording data.

8. The method according to claim 7, wherein the pixels of the second hologram are formed at shorter pitch than the pitch of the pixels of the first hologram.

9. The method according to claim 7, wherein the laser-irradiation on the recording layer is performed simultaneously with the laser-irradiation on the heat-generating layer.

10. The method according to claim 7, wherein said first and second substrates are light transmitting substrates.

11. An optical information recording medium comprising:
a recording layer formed on or over a first substrate;
a semitransparent reflective layer formed on or over the recording layer; and
a heat-generating layer, a reflective layer, and a transformation layer formed over the semitransparent reflective layer;
wherein the reflective layer comprises pixels of a first hologram of concavities and convexities formed thereon in the direction of the thickness, wherein the heat-generating layer is configured to generate heat and be transformed when being illuminated by laser beams, and wherein the reflective layer is further configured to form pixels of a second hologram when being transformed in association with transformation of the heat-generating layer.

12. The medium of claim 11, further comprising a second substrate located over the recording layer and the semitransparent reflective layer and below the heat-generating layer, the reflective layer, and the transformation layer.

13. The medium of claim 11, wherein said first substrate is a light transmitting substrate.

14. The medium of claim 12, wherein said first and second substrates are light transmitting substrates.

15. A method of forming hologram on an optical information recording medium, comprising:
providing an optical information recording medium, the medium comprising a recording layer formed on or over a first substrate, a semitransparent reflective layer formed on or over the recording layer; and a heat-generating layer, a reflective layer, and a transformation layer formed over the semitransparent reflective layer, wherein the reflective layer comprises pixels of a first hologram of concavities and convexities formed thereon in the direction of the thickness; and
forming pixels for a second hologram on the reflective layer by irradiating the heat-generating layer with a laser beam via the first substrate from the same side as the side irradiated with the laser beam when recording data.

16. The method of claim 15, wherein said first substrate is a light transmitting substrate.
